(19) United States
(12) Patent Application Publication
(10) Pub. No.: US 2012/0261046 A1
(43) Pub. Date: Oct. 18, 2012

(54) Comprising Casing Reinforcement Cables Having a Low Perviousness, and Variable Rubber Mixture Thickness

(75) Inventors: Alain Domingo, Orleat (FR); Christelle Chaulet, Clermont-Ferrand (FR)

(73) Assignees: Michelin Recherche et Technique S.A., Granges-Paccot (CH); Societe de Technologie Michelin, Clermont-Ferrand (FR)

(21) Appl. No.: 13/501,095

(22) PCT Filed: Oct. 5, 2010
(86) PCT No.: PCT/EP2010/064827

§ 371 Date: Jul. 2, 2012

(30) Foreign Application Priority Data
Oct. 7, 2009 (FR) 0956991

(51) Int. Cl. B60C 9/16

(52) U.S. Cl. 152/548

(57) ABSTRACT

A tire having a radial carcass reinforcement, comprising at least one layer of metal reinforcing elements, said tire comprising a crown reinforcement, which is itself covered radially with a tread, said tread being joined to two beads via two sidewalls. The metal reinforcing elements of at least one layer of the carcass reinforcement are non-hooped cords having, in the permeability test, a flow rate of less than 20 cm³/min and, in a radial plane, at least over part of the meridian profile of the tire, the thickness of the rubber compound between the inner surface of the cavity of the tire and that point of a metal reinforcing element of the carcass reinforcement which is closest to said inner surface of the cavity is less than or equal to 3.5 mm and the ratio between the thicknesses of rubber compound between the inner surface of the cavity of the tire and that point of a metal reinforcing element of the carcass reinforcement which is closest to said inner surface of the cavity of two distinct parts of the tire is greater than 1.15.

The present invention relates to a tire having a radial carcass reinforcement and more particularly to a tire intended to equip heavy-goods vehicles running at sustained speed, such as, for example, lorries, tractors, trailers or buses.

The reinforcement of tires, and especially of heavy-goods vehicle tires, is at the present time—and most often—formed from a stack of one or more plies conventionally denoted as “carcass plies”, “crown plies”, etc. This way of denoting the reinforcements derives from the manufacturing process, which consists in producing a series of semi-finished products in the form of plies, which are provided with often longitudinal thread-like reinforcing members that are subsequently assembled or stacked so as to build a tire blank. The plies are produced flat, with large dimensions, and are then cut up according to the dimensions of a given product. The assembly of the plies is also carried out, firstly, approximately flat. The blank thus produced then undergoes a forming operation so as to adopt the typical toroidal profile of tires. The semi-finished or “finish” products are then applied to the blank so as to obtain a product ready to be vulcanized.

Such a “conventional” process involves, in particular in respect of the phase of manufacturing the tire blank, the use of an anchoring element (generally a bead wire) used to anchor or retain the carcass reinforcement in the bead zone of the tire. Thus, for this type of process, a portion of all of the plies making up the carcass reinforcement (or only one part thereof) is turned up around a bead wire placed in the bead of the tire. This anchors the carcass reinforcement in the bead.

The generalization in industry of this type of conventional process, despite many variations in the way in which the plies and the assemblies are produced, has led those skilled in the art to use a vocabulary taken from the process: hence the generally accepted terminology comprising, in particular, the terms “plies”, “carcass”, “bead wire”, “shaping”, to denote the transition from a flat profile to a toroidal profile, etc.

Nowadays, there are tires which strictly speaking do not have “plies” or “bead wires” according to the above definitions. For example, document EP 0 582 196 discloses tires manufactured without the aid of semi-finished products in the form of plies. For example, the reinforcing elements of the various reinforcement structures are applied directly to the adjacent layers of rubber compounds, the whole assembly being applied in successive layers on a toroidal core, the shape of which results directly in a profile similar to the final profile of the tire under manufacture. Thus, in this case, there are no longer “semi-finished” products or “plies” or “bead wires”. The base products, such as the rubber compounds and the reinforcing elements in the form of threads or filaments, are directly applied to the core. Since this core is toroidal in shape, it is no longer necessary to form the blank in order to go from a flat profile to a torus-shaped profile.

Moreover, the tires disclosed in the above document do not have the “conventional” carcass ply upturn around a bead wire. This type of anchoring is replaced with an arrangement in which circumferential threads are placed adjacent to said sidewall reinforcement structure, the whole assembly being embedded in an anchoring or bonding rubber compound.

There are also assembly processes on a toroidal core using semi-finished products especially suitable for rapid, effective and simple laying on a central core. Finally, it is also possible to use a hybrid comprising both certain semi-finished products, in order to produce certain architectural aspects (such as plies, bead wires, etc.), whereas others are produced by direct application of compounds and/or reinforcing elements.

In the present document, to take into account recent technological developments both in the manufacturing field and in product design, the conventional terms such as “plies”, “bead wires”, etc. are advantageously replaced with neutral terms or terms that are independent of the type of process used. Thus, the term “carcass-type reinforcing member” or “sidewall reinforcing member” is valid for denoting the reinforcing elements of a carcass ply in the conventional process, and the corresponding reinforcing elements, which are in general applied to the sidewalls, of a tire built using a process without semi-finished products. As regards the term “anchoring zone”, this may denote just as well the “conventional” carcass ply upturn around a bead wire of a conventional process as the assembly formed by the circumferential reinforcing elements, the rubber compound and the adjacent sidewall reinforcing portions of a bottom zone produced by a process with application on a toroidal core.

In general in heavy-goods vehicle tires, the carcass reinforcement is anchored on either side in the region of the bead and is surmounted radially by a crown reinforcement consisting of at least two superposed layers and formed from threads or cords that are parallel in each layer and crossed from one layer to the next, making angles of between 10° and 45° with the circumferential direction. Said working layers, forming the working reinforcement, may be covered with at least one protective layer formed from advantageously metal extensible reinforcing elements, called elastic elements. The crown reinforcement may also comprise a layer of low-extensibility metal threads or cords making an angle of between 45° and 90° with the circumferential direction, this ply, called triangulation ply, being located radially between the carcass reinforcement and the first crown ply called the working ply, these being formed from parallel threads or cords at angles of at most equal to 45° in absolute value. The triangulation ply forms, with at least said working ply, a triangulated reinforcement which undergoes, when subjected to the various stresses, little deformation, the essential role of the triangulation ply being to take up the transverse compressive forces to which all of the reinforcing elements in the crown region of the tire are subjected.

In the case of heavy-goods vehicle tires, a single protective layer is usually present and its protecting elements are, in most cases, oriented in the same direction and at the same angle in absolute value as those of the reinforcing elements of the radially outermost, and therefore radially adjacent, working layer. In the case of civil engineering vehicle tires, intended for running on more or less uneven ground, the presence of two protective layers is advantageous, the reinforcing elements being crossed from one layer to the next and the reinforcing elements of the radially inner protective layer being crossed with the inextensible reinforcing elements of the radially outer working layer adjacent to said radially inner protective layer.

The circumferential direction, or longitudinal direction, of the tire is the direction corresponding to the periphery of the tire and defined by the running direction of the tire.

The transverse or axial direction of the tire is parallel to the rotation axis of the tire.

The radial direction is a direction cutting the rotation axis of the tire and perpendicular thereto.

The rotation axis of the tire is the axis about which it rotates in normal use.

A radial or meridian plane is a plane that contains the rotation axis of the tire.

The circumferential median, or equatorial, plane is a plane perpendicular to the rotation axis of the tire and that divides the tire into two halves.

Certain current “road” tires are intended to run at high speed on increasingly long journeys, because of the improvements in road networks and the growth of motorway networks throughout the world. All the conditions, under which such a tire is called upon to run, without doubt enable the tire to be run for a larger number of kilometers, since the wear of the tire is less. However, the endurance of this tire is prejudiced. To permit one or even two retreading operations on such tires, so as to extend their lifetime, it is necessary to preserve a structure and especially a carcass reinforcement with endurance properties which are sufficient to withstand said retreading operations.

Prolonged running under particularly severe conditions of tires thus constructed effectively introduces limits in terms of endurance of these tires.

The elements of the carcass reinforcement are in particular subjected to flexural and compressive stresses during running which adversely affect their endurance. The cords that make up the reinforcing elements of the carcass layers are in fact subjected to large stresses when the tires are running, especially to repeated flexural stresses or variations in curvature, leading to friction between the threads, and therefore wear and fatigue: this phenomenon is termed “fatigue fretting”.

To fulfill their function of strengthening the carcass reinforcement of the tire, said cords must firstly have good flexibility and a high endurance in flexure, which means in particular that their threads have to have a relatively small diameter, preferably less than 0.28 mm, more preferably less than 0.25 mm, generally smaller than that of the threads used in conventional cords for the crown reinforcements of tires.

The cords of the carcass reinforcement are also subjected to the phenomenon of “fatigue-corrosion” due to the very nature of the cords, which promote the passage of corrosive agents such as oxygen and moisture or even drain said agents. Specifically, air or water penetrating the tire, for example as a result of degradation following a cut or more simply because of the permeability, albeit low, of the inner surface of the tire, may be conveyed by the channels formed within the cords because of their very structure.

All these fatigue phenomena, which are generally grouped together under the generic term “fatigue-fretting-corrosion”, are the cause of progressive degradation of the mechanical properties of the cords and may, under the severest running conditions, affect the lifetime of said cords.

To improve the endurance of these cords of the carcass reinforcement, it is known in particular to increase the thickness of the rubber layer that forms the internal wall of the cavity of the tire in order to minimize the permeability of said layer. This layer is usually composed partly of a butyl rubber so as to better seal the tire. This type of material has the drawback of increasing the cost of the tire.

It is also known to modify the construction of said cords so as in particular to increase their penetrability by the rubber and thus limit the size of the passages of oxidizing agents.

Moreover, the usage of tires on heavy-goods vehicles for road haulage, especially when a double configuration on a driving axle or on trailers is used, is leading to them being unintentionally used in deflated mode. This is because analyses carried out have shown that it is often the case that tires are used in under-inflated mode without the driver being aware of this. Under-inflated tires are thus being regularly used over considerable distances travelled. A tire used in this way undergoes larger deformations than under the normal conditions of use, which may lead to deformation of the cords of the carcass reinforcement of the “buckling” type, which deformations are greatly detrimental, in particular for withstanding the stresses due to the inflation pressures.

To limit this problem due to the risk of buckling of the reinforcing elements of the carcass reinforcement, it is known to use cables wrapped with an additional thread surrounding the cord and preventing any risk of the cord or the constituent threads of the cord buckling. The tires produced in this way, although there is less of a risk of them being damaged due to running at low inflation pressure, experience a reduction in performance in terms of flexural endurance, especially due to friction between the hoop thread and the outer threads of the cord during deformation of the tire when it is running.

It is also known to alleviate this cord buckling problem when an under-inflated tire is running, to increase, at least locally, in the regions facing the region of the carcass reinforcement liable to buckle, the thickness of the rubber layer that forms the internal wall of the cavity of the tire. As explained above, any increase, even a local increase, in the thickness of the rubber layer separating the carcass reinforcement from the cavity of the tire results in a higher cost of the tire.

The inventors were thus tasked with providing heavy-goods vehicles with tires the wear performance of which is maintained for road usage and in particular the endurance performance of which is improved, especially with regard to “fatigue-corrosion” or “fatigue-fretting-corrosion” phenomena, irrespective of the running conditions, in particular in terms of inflation, the manufacturing cost of said tires remaining acceptable.

This objective has been achieved according to the invention by a tire having a radial carcass reinforcement, consisting of at least one layer of reinforcing elements, said tire comprising a crown reinforcement, which is itself covered radially with a tread, said tread being joined to two beads via two sidewalls, the metal reinforcing elements of at least one layer of the carcass reinforcement being non-hooped cords having, in the permeability test, a flow rate of less than 20 cm³/min, in a radial plane, at least over part of the meridian profile of the tire, the thickness of the rubber compound between the inner surface of the cavity of the tire and that point of a metal reinforcing element of the carcass reinforcement which is closest to said inner surface of the cavity being less than or equal to 3.5 mm and, in a radial plane, the ratio between the thicknesses of rubber compound between the inner surface of the cavity of the tire and that point of a metal reinforcing element of the carcass reinforcement which is closest to said inner surface of the cavity of two distinct parts of the tire being greater than 1.15 and preferably greater than 1.35.

The permeability test is used to determine longitudinal permeability to air of the tested cords, by measuring the volume of air passing through a test specimen under constant pressure for a given time. The principle of such a test, well known to those skilled in the art, is to demonstrate the effectiveness of the treatment of a cord for making it impermeable to air. The test has been described for example in the standard ASTM D2692-98.

The test is carried out on cords directly extracted, by stripping, from the vulcanized rubber plies that they reinforce, and therefore on cords that have been penetrated by cured rubber.

The test is carried out on a 2 cm length of cord, and therefore cord coated with its surrounding rubber composition (or coating rubber) in the cured state, in the following manner: air is sent into the cord, under a pressure of 1 bar, and the volume of air leaving it is measured using a flowmeter (calibrated for example from 0 to 500 cm³/min). During the measurement, the cord specimen is blocked in a compressed seal (for example a seal made of dense foam or rubber) in such a way that only the amount of air passing through the cord from one end to the other, along its longitudinal axis, is taken into account in the measurement. The sealing provided by the seal itself is checked beforehand using a solid rubber test specimen, that is to say one without a cord.

The measured average air flow rate (average over 10 test specimens) is lower the higher the longitudinal impermeability of the cord. Since the measurement is made with an accuracy of ±0.2 cm³/min, the measured values equal to or less than 0.2 cm³/min are considered to be zero and correspond to a cord that may be termed airtight (completely airtight) along its axis (i.e. in its longitudinal direction).

This permeability test also constitutes a simple means of indirectly measuring the degree of penetration of the cord by a rubber composition. The measured flow rate is lower the higher the degree of penetration of the cord by the rubber.

Cords having in the permeability test a flow rate of less than 20 cm³/min have a degree of penetration greater than 66%.

The degree of penetration of a cord may also be estimated using the method described below. In the case of a layered cord, the method consists firstly in removing the outer layer on a specimen having a length between 2 and 4 cm and then measuring, along a longitudinal direction and along a given axis, the sum of the lengths of rubber compound divided by the length of the specimen. These rubber compound length measurements exclude the spaces not penetrated along this longitudinal axis. The measurements are repeated along three longitudinal axes distributed over the periphery of the specimen and repeated on five cord specimens.

When the cord comprises several layers, the first, removal step is repeated with the newly external layer and the rubber compound lengths measured along longitudinal axes.

All the ratios of rubber compound lengths to specimen lengths thus determined are then averaged so as to define the degree of penetration of the cord.

The rubber compound thickness between the inner surface of the cavity of the tire and that point of a reinforcing element closest to said surface is equal to the length of the orthogonal projection of the end of the point of a reinforcing element closest to said surface on the inner surface of the cavity of the tire.

The rubber compound thickness measurements are carried out on a cross section of a tire, the tire therefore being in an uninflated state.

According to a preferred embodiment of the invention, the cords of the carcass reinforcement have, in the permeability test, a flow rate of less than 10 cm³/min and more preferably less than 2 cm³/min.

According to an advantageous embodiment of the invention, the thickness of rubber compound between the inner surface of the cavity of the tire and that point of a metal reinforcing element of the carcass reinforcement which is closest to said inner surface of the cavity is less than or equal to 3.5 mm over at least two thirds of the meridian profile of the tire.

The inventors have demonstrated that a tire produced in this way according to the invention leads to very advantageous improvements in terms of the compromise between endurance and manufacturing cost. Indeed, the endurance properties of such a tire are at least as good as with the best solutions mentioned above, whether under normal running conditions or when running in under-inflated mode. Moreover, since the thickness of the rubber compound layer between the carcass reinforcement and the cavity of the tire is at least locally less than that of standard tires, this thickness constituting one of the most expensive components of the tire, the manufacturing cost of the tire is lower than that of a standard tire. The cords of the carcass reinforcement, having a flow rate of less than 20 cm³/min in the permeability test, make it possible, on the one hand, to limit the risks due to corrosion and, on the other hand, seem to confer an anti-buckling effect thus enabling the thickness of the rubber compounds between the inner surface of the cavity of the tire and the carcass reinforcement to be minimized. Over certain regions of the meridian profile of the tire, the thickness of the layer of rubber compound between the carcass reinforcement and the cavity of the tire is designed according to the invention to be greater so as to limit as far as possible any risk of the cords corroding, for example in the highly stressed regions in terms of bending stresses under the nominal operating conditions.

According to a preferred embodiment of the invention, in a radial plane, at least over part of the meridian profile of the tire, the thickness of the rubber compound between the inner surface of the cavity of the tire and that point of a metal reinforcing element of the carcass reinforcement which is closest to said inner surface of the cavity is greater than 3.5 mm and preferably greater than 4 mm.

More preferably, the meridian length of part of the profile of the tire, of which the thickness of rubber compound between the inner surface of the cavity of the tire and that point of a metal reinforcing element of the carcass reinforcement which is closest to said inner surface of the cavity is greater than 3.5 mm, is between 5 and 20 mm.

Advantageously according to the invention, the thickness of rubber compound between the inner surface of the cavity of the tire and that point of a metal reinforcing element of the carcass reinforcement which is closest to said inner surface of the cavity is less than or equal to 3.5 mm when the difference in curvature between the part in question of the meridian profile of the carcass reinforcement in the deformed region, because of the squashing in the area of contact and in the region opposite the area of contact, is less than 0.008 mm⁻¹ under the nominal operating conditions.

The part in question of the meridian profile of the carcass reinforcement is the part surrounding said point of a metal reinforcing element where the measurement of the thickness is made.

Likewise, the thickness of rubber compound between the inner surface of the cavity of the tire and that point of a metal reinforcing element of the carcass reinforcement which is closest to said inner surface of the cavity is advantageously greater than 3.5 mm when the difference in curvature between the part in question of the meridian profile of the carcass reinforcement in the deformed region, because of the squashing in the area of contact and in the region opposite the area of contact, is greater than 0.008 mm⁻¹ under the nominal operating conditions. These parts of the meridian profile correspond to those parts of the tire which are most stressed by deformation and are for example regions of the tire sidewalls facing the rim flanges of the wheel on which the tire is fitted or else the regions of the tire corresponding to the shoulders of the wheel.

According to a preferred variant of the invention, the meridian length of the profile of the tire comprises at most four parts, the thickness of rubber compound of which between the inner surface of the cavity of the tire and that point of a metal reinforcing element of the carcass reinforcement which is closest to said inner surface of the cavity is greater than 3.5 mm.

According to this variant of the invention, at least two parts of the profile of the tire, the thickness of rubber compound of which between the inner surface of the cavity of the tire and that point of a metal reinforcing element of the carcass reinforcement which is closest to said inner surface of the cavity is greater than 3.5 mm, are centered to within 20 mm, measured over the curvilinear abscissa of the inner surface of the cavity of the tire, on the orthogonal projection of the shoulder ends of the tire onto the inner surface of the tire.

In the context of the invention, a shoulder end is defined, in the region of the shoulder of the tire, by the orthogonal projection on the outer surface of the tire of the intersection of the tangents to the surfaces of an axially outer end of the tread (top of the tread pattern) on one side and of the radially outer end of a sidewall on the other.

According to this variant of the invention too, at least two parts of the profile of the tire, the thickness of rubber compound of which between the inner surface of the cavity of the tire and that point of a metal reinforcing element of the carcass reinforcement which is closest to said inner surface of the cavity is greater than 3.5 mm, are centered to within 20 mm, measured on the curvilinear abscissa of the inner surface of the cavity of the tire, on the orthogonal projection to the inner surface of the tire of those points of the outer surface of the tire which are intended to come into contact with the radially outermost point of a rim flange.

According to a preferred embodiment of the invention, the rubber compound between the cavity of the tire and the reinforcing elements of the radially innermost carcass reinforcement layer consisting of at least two layers of rubber compound, for those parts of the meridian profile of the tire having a thickness of rubber compound between the inner surface of the cavity of the tire and that point of a metal reinforcing element of the carcass reinforcement which is closest to said inner surface of the cavity of less than or equal to 3.5 mm, the radially innermost layer of rubber compound has a thickness of less than 2 mm and preferably less than 1.8 mm. As explained above, usually this layer is partly composed of butyl rubber so as to increase the impermeability of the tire and since this type of material has a not inconsiderable cost, the reduction in this layer is favorable.

Also preferably according to the invention, in a radial plane, over at least that part of the meridian profile of the tire on which the thickness of rubber compound between the inner surface of the cavity of the tire and that point of the metal reinforcing element of the carcass reinforcement which is closest to said inner surface of the cavity is less than or equal to 3.5 mm, the thickness of the rubber compound forming the inner surface of the cavity of the tire is less than 1.7 mm.

According to this preferred embodiment of the invention, in the regions of smaller thickness of the layer of rubber compound between the carcass reinforcement and the cavity of the tire, the thickness of the rubber compound forming the inner surface of the cavity of the tire is less than 1.7 min. This rubber compound forming the inner surface of the cavity of the tire, usually consisting of butyl rubber, is a material of non-negligible cost in the construction of the tire. A reduction in the thickness thereof to values of less than 1.7 mm over part of the meridian profile of the tire advantageously results in a lower cost of the tire.

Also advantageously, in a radial plane, the ratio of the thicknesses of the rubber compound forming the inner surface of the cavity of the tire into separate parts of the tire is greater than 1.15.

Again preferably according to the invention, for those parts of the meridian profile of the tire having a thickness of rubber compound between the inner surface of the cavity of the tire and that point of a metal reinforcing element of the carcass reinforcement which is closest to said inner surface of the cavity of less than or equal to 3.5 mm, the layer of rubber compound radially adjacent to the radially innermost layer of rubber compound has a thickness of less than 2.5 mm and preferably less than 2 mm. The thickness of this layer, the constituents of which make it possible in particular to fix the oxygen of the air, may also be reduced so as to further reduce the cost of the tire.

The thickness of each of these two layers is equal to the length of the orthogonal projection of a point on one surface to the other surface of said layer.

According to one advantageous embodiment of the invention, the metal reinforcing elements of at least one layer of the carcass reinforcement are cords having at least two layers, at least an inner layer being sheathed with a layer consisting of a crosslinkable or crosslinked rubber composition, preferably one based on at least one diene elastomer.

The invention also provides a tire having a radial carcass reinforcement consisting of at least one layer of reinforcing elements, said tire comprising a crown reinforcement, which is itself covered radially with a tread, said tread being joined to two beads via two sidewalls, the metal reinforcing elements of at least one layer of the carcass reinforcement being non-hooped cords having at least two layers, at least an inner layer being sheathed with a layer consisting of a crosslinkable or crosslinked rubber composition, preferably one based on at least one diene elastomer, and, in a radial plane, at least over part of the meridian profile of the tire, the thickness of the rubber compound between the inner surface of the cavity of the tire and that point of a metal reinforcing element of the carcass reinforcement closest to said inner surface of the cavity being less than or equal to 3.5 mm and, in a radial plane, the ratio between the thicknesses of rubber compound between the inner surface of the cavity of the tire and that point of a metal reinforcing element of the carcass reinforcement which is closest to said inner surface of the cavity of two distinct parts of the tire being greater than 1.15 and preferably greater than 1.35.

The expression “composition based on at least one diene elastomer” is understood to mean, as is known, that the composition comprises predominantly (i.e. with a mass fraction greater than 50%) this or these diene elastomers.

It should be noted that the sheath according to the invention extends continuously around the layer that it covers (that is to say this sheath is continuous in the “orthoradial” direction of the cord, which is perpendicular to its radius) so as to form a continuous sleeve having a cross section that is advantageously almost circular.

It should also be noted that the rubber composition of this sheath is crosslinkable or crosslinked, that is to say it includes, by definition, a suitable crosslinking system thus allowing the composition to crosslink while it undergoes curing (i.e. it cures and does not melt). Thus, this rubber composition may be termed “non-melting”, because it cannot be melted by heating it to any temperature.

The term “diene” elastomer or rubber is understood, as is known, to mean an elastomer coming at least partly (i.e. a homopolymer or a copolymer) from diene monomers (monomers carrying two carbon-carbon double bonds, whether conjugated or not).

Diene elastomers, in a known manner, may be put into two categories: those called “essentially unsaturated” diene elastomers and those called “essentially saturated” diene elastomers. In general, an “essentially unsaturated” diene elastomer is understood here to mean a diene elastomer obtained at least partly from conjugated diene monomers having an original content of diene units (conjugated dienes) which is greater than 15% (mol %). Thus, for example, diene elastomers such as butyl rubbers or copolymers of dienes and α-olefins of the EPDM type do not fall within the above definition and in particular can be termed “essentially saturated” diene elastomers (having an original content of diene units that is low or very low and always less than 15%). In the category of “essentially unsaturated” diene elastomers, the term “highly unsaturated” diene elastomer is understood to mean in particular a diene elastomer having an original content of diene units (conjugated dienes) of greater than 50%.

Given these definitions, a diene elastomer that can be used in the cord according to the invention is understood more particularly to mean:
(a) any homopolymer obtained by polymerizing a conjugated diene monomer having from 4 to 12 carbon atoms;
(b) any copolymer obtained by copolymerizing one or more conjugated dienes with one another or with one or more aromatic vinyl compounds having from 8 to 20 carbon atoms;
(c) a ternary copolymer obtained by copolymerizing ethylene, an α-olefin having 3 to 6 carbon atoms with an unconjugated diene monomer having from 6 to 12 carbon atoms, such as for example, the elastomers obtained from ethylene or propylene with an unconjugated diene monomer of the aforementioned type, such as for example 1,4-hexadiene, ethylidene norbornene and dicyclopentadiene;
(d) an isobutene/isoprene copolymer (butyl rubber), and also halogenated, in particular chlorinated or brominated versions of this type of copolymer.

Although it applies to any type of diene elastomer, the present invention is primarily implemented with essentially unsaturated diene elastomers, in particular of type (a) or (b) above.

Thus, the diene elastomer is preferably chosen from the group formed by polybutadienes (BR), natural rubber (NR), synthetic polyisoprenes (IR), various butadiene copolymers, various isoprene copolymers and blends of these elastomers. More preferably, such copolymers are chosen from the group formed by stirene-butadiene copolymers (SBR), butadiene-isoprene copolymers (BIR), stirene-isoprene copolymers (SIR) and stirene-butadiene-isoprene copolymers (SBIR).

More preferably according to the invention, the diene elastomer chosen predominantly (i.e. in respect of more than 50 phr) consists of an isoprene elastomer. The term “isoprene elastomer” is understood to mean, as is known, an isoprene homopolymer or copolymer, in other words a diene elastomer chosen from the group formed by natural rubber (NR), synthetic polyisoprenes (IR), various isoprene copolymers and blends of these elastomers.

According to one advantageous embodiment of the invention, the diene elastomer chosen consists exclusively (i.e. for 100 phr) of natural rubber, synthetic polyisoprene or a blend of these elastomers, the synthetic polyisoprene having a content (in mol %) of 1,4-cis bonds preferably greater than 90%, and even more preferably greater than 98%.

It would also be possible to use, according to one particular embodiment of the invention, cuts (blends) of this natural rubber and/or these synthetic polyisoprenes with other highly unsaturated diene elastomers, especially with SBR or BR elastomers as mentioned above.

The rubber sheath of the cord of the invention may contain one or more diene elastomers, it being possible for these to be used in combination with any type of synthetic elastomer other than those of diene type, or even with polymers other than elastomers, for example thermoplastic polymers, these polymers other than elastomers then being present by way of minority polymer.

Although the rubber composition of said sheath is preferably devoid of any plastomer and contains only a diene elastomer (or blend of diene elastomers) as polymeric base, said composition could also include at least one plastomer with a mass fraction xₚ which is less than the mass fraction xₑ of the elastomer(s). In such a case, the following relationship preferably applies: 0<xₚ<0.5xₑ and more preferably the following relationship applies: 0<xₚ<0.1xₑ.

Preferably, the crosslinking system of the rubber sheath is a system called a vulcanization system, that is to say one based on sulphur (or on a sulphur donor) and a primary vulcanization accelerator. Added to this base vulcanization system may be various known secondary vulcanization accelerators or vulcanization activators. Sulphur is used with a preferential amount of between 0.5 and 10 phr, more preferably between 1 and 8 phr, and the primary vulcanization accelerator, for example a sulphonamide, is used with a preferential amount of between 0.5 and 10 phr, more preferably between 0.5 and 5.0 phr.

The rubber composition of the sheath according to the invention includes, besides said crosslinking system, all the common ingredients that can be used in rubber compositions for tires, such as reinforcing fillers based on carbon black and/or an inorganic reinforcing filler such as silica, anti-ageing agents, for example antioxidants, extender oils, plasticizers or processing aids, which make it easier to process the compositions in the uncured state, methylene donors and acceptors, resins, bismaleimides, known adhesion promoter systems of the RFS (resorcinol-formaldehyde-silica) type or metal salts, especially cobalt salts.

Preferably, the composition of the rubber sheath has, in the crosslinked state, a secant modulus in extension with 10% elongation (denoted M10), measured according to the ASTM D 412 (1998) standard, of less than 20 MPa and more preferably less than 12 MPa, in particular between 4 and 11 MPa.

Preferably, the composition of this sheath is chosen to be the same as the composition used for the rubber matrix that the cords according to the invention are intended to reinforce. Thus, there is no problem of any incompatibility between the respective materials of the sheath and the rubber matrix.

Preferably, said composition is based on natural rubber and contains carbon black as reinforcing filler, for example carbon black of ASTM 300, 600 or 700 grade (for example N326, N330, N347, N375, N683 or N772).

According to a variant of the invention, the metal reinforcing elements of at least one layer of the carcass reinforcement are layered metal cords of [L+M] or [L+M+N] construction usable as reinforcing element of a tire carcass reinforcement, comprising a first layer C1 having L threads of diameter d₁ where L ranges from 1 to 4, surrounded by at least one intermediate layer C2 having M threads of diameter d₂ wound together in a helix with a pitch p₂ where M ranges from 3 to 12, said layer C2 being optionally surrounded by an outer layer C3 of N threads of diameter d₃ wound together in a helix with a pitch p₃, where N ranges from 8 to 20, a sheath consisting of a crosslinkable or crosslinked rubber composition based on at least one diene elastomer covering, in the [L+M] construction, said first layer C1 and, in the [L+M+N] construction, at least said layer C2.

Preferably, the diameter of the threads of the first layer of the inner layer (C1) is between 0.10 and 0.5 mm and the diameter of the threads of the outer layers (C2, C3) is between 0.10 and 0.5 mm.

More preferably, the helix pitch with which said threads of the outer layer (C3) are wound is between 8 and 25 mm.

Within the meaning of the invention, the pitch represents the length, measured parallel to the axis of the cord, at the end of which a thread having this pitch makes one complete turn around the axis of the cord; thus, if the axis is sectioned by two planes perpendicular to said axis and separated by a length equal to the pitch of a thread of a constituent layer of the cord, the axis of this thread in these two planes has the same position on the two circles corresponding to the layer of the thread in question.

Advantageously, the cord has one, and more preferably still all of the following characteristics, which is/are confirmed:
the layer C3 is a saturated layer, that is to say there exists insufficient space in this layer to add to it at least an (N+1)th thread of diameter d₃, N then representing the maximum number of threads that can be wound as a layer around the layer C2;
the rubber sheath furthermore covers the inner layer C1 and/or separates the pairwise adjacent threads of the intermediate layer C2;
the rubber sheath covers practically the radially internal semi-circumference of each thread of the layer C3 in such a way that it separates the pairwise adjacent threads of this layer C3.

In the L+M+N construction according to the invention, the intermediate layer C2 preferably comprises six or seven threads and the cord according to the invention then has the following preferential characteristics (d₁, d₂, d₃, p₂ and p₃ in mm):
(i) 0.10<d₁<0.28;
(ii) 0.10<d₂<0.25;
(iii) 0.10<d₃<0.25;
(iv) M=6 or M=7;
(v) 5π(d₁+d₂)<p₂≦p₃<5π(d₁+2d₂+d₃);
(vi) the threads of said layers C2, C3 are wound in the same twist direction (S/S or Z/Z).

Preferably, characteristic (v) is such that p₂=p₃, in such a way that the cord is said to be “compact” considering moreover characteristic (vi) (threads of the layers C2 and C3 wound in the same direction).

According to characteristic (vi), all the threads of the layers C2 and C3 are wound in the same twist direction, that is to say either in the direction S (“S/S” arrangement) or in the direction Z (“Z/Z” arrangement). By winding the layers C2 and C3 in the same direction, it is advantageously possible in the cord according to the invention to minimize the friction between these two layers C2 and C3 and therefore the wear of the threads constituting them (since there is no longer crossed contact between the threads).

Preferably, the cord of the invention is a layered cord of 1+M+N construction, that is to say that its inner layer C1 consists of a single thread.

Again advantageously, the (d₁/d₂) ratios are preferably set within given limits, according to the number M (6 or 7) of threads in the layer C2, as follows:
for M=6: 0.9<(d₁/d₂)<1.3;
for M=7: 1.3<(d₁/d₂)<1.6.

Too low a value of the ratio d₁/d₂ may be prejudicial to wear between the inner layer and the threads of the layer C2. As for too high a value, this may impair the compactness of the cord, for a barely modified definitive level of strength, and may also impair its flexibility. The greater rigidity of the inner layer C1 due to too high a diameter d₁ could moreover be prejudicial to the very feasibility of the cord during the cabling operations.

The threads of the layers C2 and C3 may have the same diameter or this may differ from one layer to the other. Preferably, threads of the same diameter (d₂=d₃) are used, especially to simplify the cabling process and to lower the costs.

The maximum number Nₘₐₓ of threads that can be wound as a single saturated layer C3 around the layer C2 depends of course on many parameters (diameter d₁ of the inner layer, number M and diameter d₂ of the threads of the layer C2, and diameter d₃ of the threads of the layer C3).

Preferably, the invention is implemented with a cord chosen from cords of 1+6+10, 1+6+11, 1+6+12, 1+7+11, 1+7+12 or 1+7+13 construction.

For a better compromise between strength, feasibility and flexural endurance of the cord, on the one hand, and penetrability by the rubber on the other hand, it is preferred for the diameters of the threads of the layers C2 and C3, whether identical or not, to be between 0.12 mm and 0.22 mm.

In such a case, it is preferred to have the following relationships, which are confirmed:
0.14<d₁<0.22;
0.12<d₂≦d₃<0.20;
5<p₂≦p₃<12 (small pitches in mm) or else 20<p₂≦p₃<30 (large pitches in mm).

A diameter less than 0.19 mm helps reduce the level of stresses undergone by the threads during the large variations in curvature of the cords, while it is preferred to choose diameters greater than 0.16 mm in particular for thread strength and industrial cost reasons.

One advantageous embodiment consists for example in choosing p₂ and p₃ to be between 8 and 12 mm, advantageously with cords of 1+6+12 construction.

Preferably, the rubber sheath has an average thickness ranging from 0.0.10 mm to 0.040 mm.

In general, the invention may be implemented, in order to form the carcass reinforcement cords described above, with any type of metal thread, especially steel thread, for example carbon steel threads and/or stainless steel threads. It is preferred to use a carbon steel but of course it is possible to use other steels or other alloys.

When a carbon steel is used, its carbon content (% by weight of steel) is preferably between 0.1% and 1.2%, more preferably from 0.4% to 1.0%. These contents represent a good compromise between the required mechanical properties of the tire and the feasibility of the thread. It should be noted that a carbon content of between 0.5% and 0.6% finally makes such steels less expensive, as they are easier to draw. Another advantageous embodiment of the invention may also consist, depending on the intended applications, in using low carbon steels, for example having a carbon content of between 0.2% and 0.5%, especially because they have a lower cost and drawing is much easier.

The cord according to the invention may be obtained by various techniques known to those skilled in the art, for example, in two steps: firstly a step in which the L+M intermediate structure or core (layers C1+C2) is sheathed via an extrusion head and secondly this step is followed by a final operation in which the N remaining threads (layer C3) are cabled or twisted around the thus sheathed layer C2. The problem of bonding in the uncured state posed by the rubber sheath, during possible intermediate winding and unwinding operations, may be solved in a manner known to those skilled in the art, for example by using an intermediate plastic film.

According to one embodiment of the invention, the crown reinforcement of the tire is formed from at least two working crown layers of inextensible reinforcing elements, which are crossed from one layer to the other making angles of between 10° and 45° with the circumferential direction.

According to other embodiments of the invention, the crown reinforcement also includes at least one layer of circumferential reinforcing elements.

A preferred embodiment of the invention also provides for the crown reinforcement to be supplemented, radially to the outside, by at least one supplementary protective layer consisting of elastic reinforcing elements oriented to the circumferential direction at an angle of between 10° and 45° and in the same sense as the angle made by the inextensible elements of the working layer that is radially adjacent thereto.

The protective layer may have an axial width smaller than the axial width of the narrowest working layer. Said protective layer may also have an axial width greater than the axial width of the narrowest working layer, such that it covers the edges of the narrowest working layer and, in the case of the radially upper layer as being the narrowest, such that it is coupled, in the axial extension of the additional reinforcement, to the widest working crown layer over an axial width so as thereafter, axially to the outside, to be decoupled from said widest working layer by profiled elements having a thickness of at least 2 mm. The protective layer formed from elastic reinforcing elements may, in the abovementioned case, on the one hand, be optionally decoupled from the edges of said narrowest working layer by profiled elements having a thickness substantially less than the thickness of the profiled elements separating the edges of the two working layers and, on the other hand, have an axial width smaller or larger than the axial width of the widest crown layer.

According to any of the embodiments of the invention mentioned above, the crown reinforcement may also be supplemented, radially to the inside between the carcass reinforcement and the radially internal working layer closest to said carcass reinforcement, with a triangulation layer of inextensible metal reinforcing elements made of steel making, with the circumferential direction, an angle of greater than 60° and in the same sense as that of the angle made by the reinforcing elements of the radially closest layer of the carcass reinforcement.

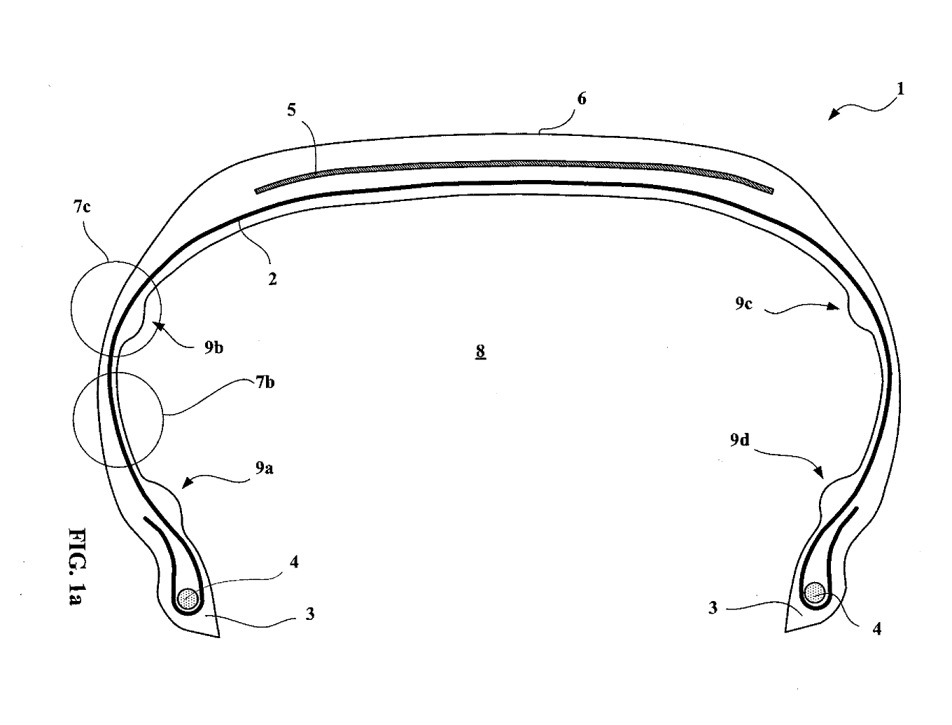

Other details and advantageous features of the invention will become apparent below from the description of exemplary embodiments of the invention with reference to FIGS. 1 to 3 which show:

FIG. 1a, a meridional view of a diagram showing a tire according to one embodiment of the invention;

FIG. 1b, an enlarged partial view of part of the diagram shown in FIG. 1a;

FIG. 1c, an enlarged partial view of another part of the diagram shown in FIG. 1a,

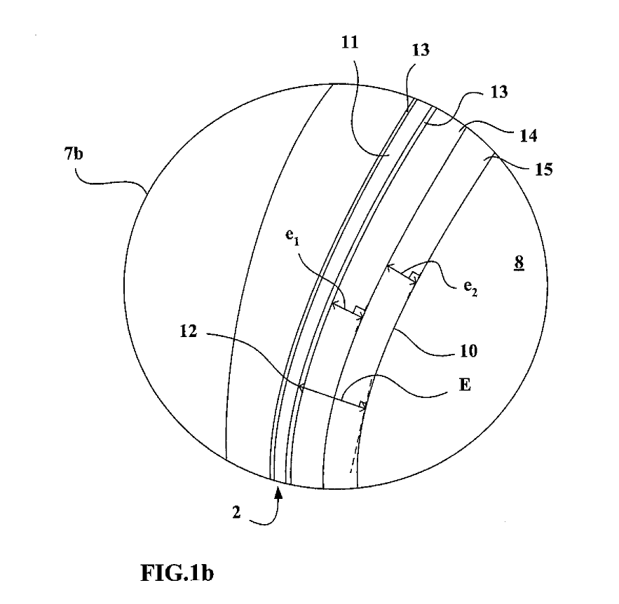

FIG. 2, a schematic representation in cross section of a carcass reinforcement cord of the tire shown in FIG. 1;

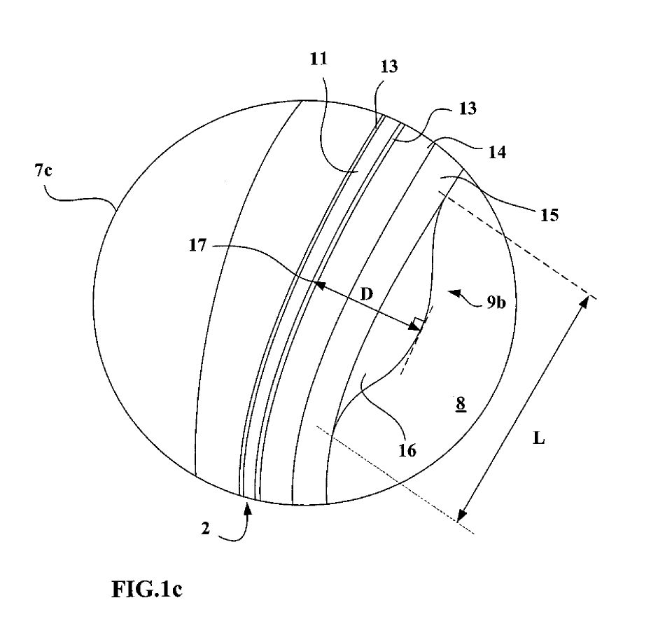

FIG. 3, a schematic representation in cross section of a first additional example of a carcass reinforcement cord according to the invention; and

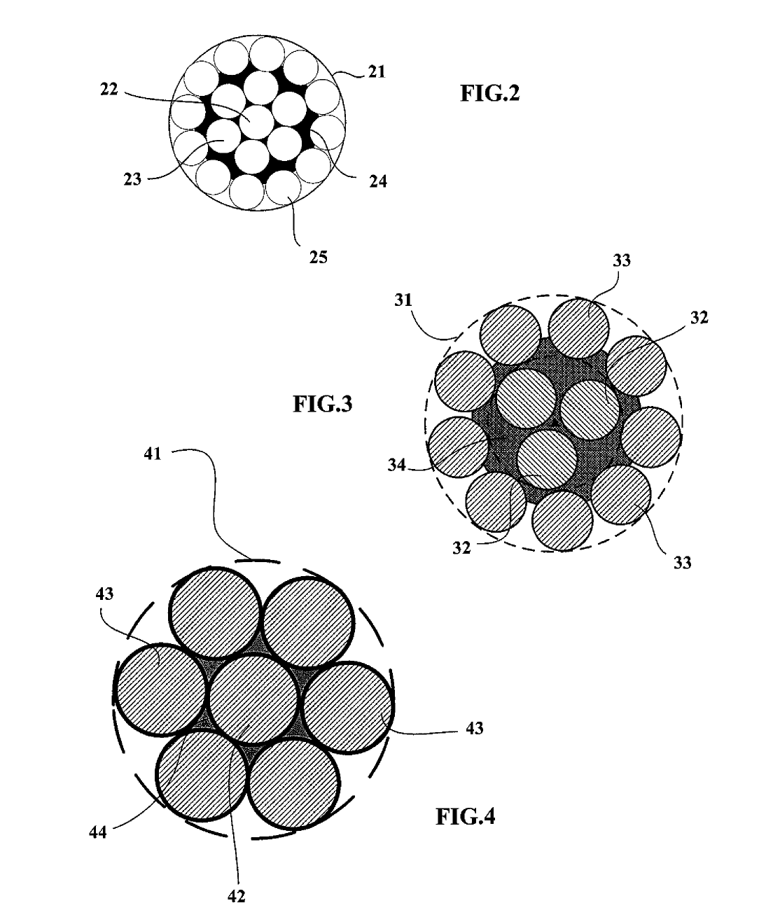

FIG. 4, a schematic representation in cross section of a second additional example of a carcass reinforcement cord according to the invention.

The figures have not been drawn to scale so as to make it simpler to understand them.

In FIG. 1a, the tire 1, of 315/70 R 22.5 type, comprises a radial carcass reinforcement 2 anchored in two beads 3 around bead wires 4. The carcass reinforcement 2 is formed by a single layer of metal cords 11 and two calendering layers 13. The carcass reinforcement 2 is hooped with a crown reinforcement 5 which is itself covered with a tread 6. The crown reinforcement 5 is formed, radially from the inside to the outside, from:
a first working layer formed from continuous non-hooped inextensible metal cords 11.35 over the entire width of the ply, said cords being oriented at an angle of 18°;
a second working layer formed from continuous non-hooped inextensible metal cords 11.35 over the entire width of the ply, said cords being oriented at an angle of 18° and crossed with the metal cords of the first working layer; and
a protective layer formed from elastic metal cords 6×35.

All these layers constituting the crown reinforcement 5 have not been shown in detail in the figures.

The inner surface 10 delimiting the cavity of the tire has irregularities such as boss shapes corresponding in accordance with the invention to parts 9a, 9b, 9c, 9d having a thickness between the inner surface 10 and the carcass reinforcement 2 which is greater than over the rest of the meridian profile of the tire.

FIG. 1b illustrates an enlargement of the region 7b of FIG. 1a and in particular indicates the thickness E of rubber compound between the inner surface 10 of the cavity 8 of the tire and the point 12 of a reinforcing element 11 closest to said surface 10. This thickness E is equal to the length of the orthogonal projection of the point 12 of a reinforcing element 11 closest to said surface 10 onto the surface 10. This thickness E is the sum of the thicknesses of the various rubber compounds placed between said reinforcing element 11 of the carcass reinforcement 2, comprising, on the one hand, the thickness of the radially inner calendering layer 13 of the carcass reinforcement and, on the other hand, thicknesses e₁, e₂ of the various layers 14, 15 of rubber compound forming the inner wall of the tire 1. These thicknesses e₁, e₂ are also equal to the length of the orthogonal projection of a point on one surface to the other surface of the layer, 14, 15 respectively, in question.

These thickness measurements are made on a cross section of the tire, which consequently is not mounted and not inflated.

The measured value of E is equal to 3.2 mm.

The values of e₁ and e₂ are equal to 1.4 mm and 1.6 mm respectively.

FIG. 1c illustrates an enlargement of the region 7c of FIG. 1a and in particular indicates the thickness D of rubber compound between the inner surface 10 of the cavity 8 of the tire and that point 17 of a reinforcing element 11 which is closest to said surface 10 in the part 9b. This thickness D is equal to the length of the orthogonal projection of the point 17 of a reinforcing element 11 which is closest to said surface 10 onto the surface 10 instead of the greatest thickness in the part 9b. This thickness D is the sum of the thicknesses of the various rubber compounds placed between said reinforcing element 11 of the carcass reinforcement 2. This is, on the one hand, the thickness of the radially inner calendering layer 13 of the carcass reinforcement and, on the other hand, the respective thicknesses of the various layers 14, 15, 16 of rubber compound forming the inner wall of the tire 1.

The layer 15 is, as described above, partly composed of butyl rubber so as to increase the sealing of the tire. The layer 14 advantageously includes constituents for especially fixing the oxygen of the air. The reduction of thicknesses of these two layers is favorable to a reduction in the cost of the tire, the constituent materials of these layers having non-negligible costs. The layer 16 provided locally on the meridian profile of the tire in the part 9b is advantageously similar to the layer 15 in terms of composition so as to enhance the sealing function in a region of the tire where it is highly stressed in terms of deformation. The parts 9a, 9b, 9c, 9d in question correspond to the shoulders of the tire and to those regions of the tire corresponding to the rim flanges of the wheel on which the tire is fitted.

The thickness D in the part 9b is equal to 4.7 mm, and therefore greater than 4 mm.

The ratio of the thickness D to the thickness E is equal to 1.47 and therefore greater than 1.15.

The length L corresponding to the meridian length of the over thickness of part 9b is equal to 15 mm, and therefore between 5 and 20 mm. The sum of the lengths of the over thicknesses of the four parts 9a, 9b, 9c, 9d is equal to 60 mm and corresponds to 8.6% of the length of the meridian profile of the wall 10 of the tire 1.

The representation in FIG. 1c shows an additional layer 16 for the part composed of butyl rubber added locally at the cavity of the tire. The nature of the layer 16 could, according to other embodiments of the invention, be different. Moreover, the local over thicknesses could also be produced for example by locally modifying the respective thicknesses of one or both of the layers 14 and 15 or else by locally inserting one or more layers between the layers 14 and 15 or else between the carcass reinforcement 2 and the layer 14.

Local increases in the thickness between the inner surface 10 and the carcass reinforcement 2 go counter to reducing the cost of the tire, but they do result in a satisfactory endurance/cost compromise.

FIG. 2 illustrates a schematic representation of the cross section through a carcass reinforcement cord 21 of the tire 1 shown in FIG. 1. This cord 21 is a non-hooped layered cord of 1+6+12 construction, consisting of a central core formed by a thread 22, an intermediate layer formed from six threads 23 and an outer layer formed from twelve threads 25.

The cord has the following characteristics (d and p in mm):
1+6+12 construction;
d₁=0.20;
d₂=0.18;
p₂=10;
d₃=0.18;
p₂=10;
(d₂/d₃)=1;
   where d₂ and p₂ are, respectively, the diameter and the helix pitch of the intermediate layer and d₃ and p₃ are, respectively, the diameter and the helix pitch of the threads of the outer layer.

The core of the cord consisting of the central core formed from the thread 22 and from the intermediate layer formed from the six threads 23 is sheathed by a rubber composition 24 based on an unvulcanized diene elastomer (in the uncured state). Sheathing of the core, consisting of the thread 22 surrounded by the six threads 23, carried out using an extrusion head, is followed by a final operation of twisting or cabling the 12 threads 25 around the core thus sheathed.

The penetrability of the cord 31, measured according to the method described above, is equal to 95%.

The elastomer composition constituting the rubber sheath 24 is made from a composition as described above and has, in the present case, the same formulation, based on natural rubber and carbon black, as that of the calendering layers 13 of the carcass reinforcement that the cords are intended to reinforce.

FIG. 3 illustrates a schematic representation of the cross section through another carcass reinforcement cord 31 that can be used in a tire according to the invention. This cord 31 is a non-hooped layered cord of 3+9 construction consisting of a central core formed from a cord consisting of three threads 32 twisted together and an outer layer formed from nine threads 33.

This cord has the following characteristics (d and p in mm):
3+9 construction;
d₁=0.18;
p₂=5;
(d₁/d₂)=1;
d₂=0.18;
p₂=10,
   where d₁ and p₁ are, respectively, the diameter and the helix pitch of the threads of the central core and d₂ and p₂ are, respectively, the diameter and the helix pitch of the threads of the outer layer.

The central core consisting of a cord formed from three threads 32 was sheathed with a rubber composition 34 based on an unvulcanized diene elastomer (in the uncured state). The sheathing of the cord 32, carried out by an extrusion head, is followed by a final operation of cabling the nine threads 33 around the core thus sheathed.

The penetrability of the cord 31, measured according to the method described above, is equal to 95%.

FIG. 4 illustrates a schematic representation of the cross section through another carcass reinforcement cord 41 that can be used in a tire according to the invention. This cord 41 is a non-hooped layered cord of 1+6 construction consisting of a central core formed from a thread 42 and an outer layer formed from six threads 43.

This cord has the following characteristics (d and p in mm):
1+6 construction;
d₁=0.200;
(d₁/d₂)=1.14;
d₂=0.175;
p₂=10,
   where d₁ is the diameter of the core and d₂ and p₂ are, respectively, the diameter and the helix pitch of the threads of the outer layer.

The central core consisting of the thread 42 was sheathed with a rubber composition 44 based on an unvulcanized diene elastomer (in the uncured state). The sheathing of the thread 42, carried out by an extrusion head, is followed by a final operation of cabling the six threads 43 around the core thus sheathed.

The penetrability of the cord 41, measured according to the method described above, is equal to 95%.

Trials were carried out on tires produced according to the invention as shown in FIGS. 1 and 2 and other trials carried out on control tires.

These control tires differ from the tires according to the invention by the cords of the carcass reinforcement not having the sheathing layer 24 and the thickness E of rubber compound between the inner surface of the cavity of the tire and the point on a reinforcing element closest to said surface being equal to 5 mm, each of the thicknesses e₁ and e₂ being equal to 2.5 mm over the entire meridian profile of the tire.

Rolling drum endurance trials were carried out on a test machine imposing a load of 4415 daN on the tires, which were run at a speed of 40 km/h, with oxygen-doped inflation of the tires. The trials were carried out on the tires according to the invention under conditions identical to those applied to the control tires. The running tests were stopped as soon as the carcass reinforcement of the tires showed degradation.

The trials thus carried out showed that the distances travelled during each of these tests are favorable for the tires according to the invention, which ran for more than 350 000 km, whereas the control tires travelled only 250 000 km.

Other rolling endurance trials on a vehicle driving axle were carried out by imposing a load of 3680 daN on the tires, which were run at a speed of 40 km/h, with a tire pressure of 0.2 bar. The trials were carried out on the tires according to the invention under conditions identical to those applied to the control tires. The running tests were carried out over a distance of 12 000 km or were stopped as soon as the carcass reinforcement of the tires showed degradation.

The trials thus carried out showed that the distances travelled during each of these tests by the tires according to the invention still allowed distances of 12 000 km to be achieved, whereas the control tires travelled at most only 10 000 km.

Furthermore, the manufacturing costs of the tires according to the invention are lower, the cost of the materials being 10% lower in the case of the tires according to the invention.

Moreover, the tires according to the invention have the advantage of being 6% lighter than the control tires.

1. A tire having a radial carcass reinforcement, comprising at least one layer of metal reinforcing elements, said tire comprising a crown reinforcement, which is itself covered radially with a tread, said tread being joined to two beads via two sidewalls, wherein the metal reinforcing elements of at least one layer of the carcass reinforcement are non-hooped cords having, in the permeability test, a flow rate of less than 20 cm³/min, wherein, in a radial plane, at least over part of the meridian profile of the tire, the thickness of the rubber compound between the inner surface of the cavity of the tire and that point of a metal reinforcing element of the carcass reinforcement which is closest to said inner surface of the cavity is less than or equal to 3.5 mm and wherein, in a radial plane, the ratio between the thicknesses of rubber compound between the inner surface of the cavity of the tire and that point of a metal reinforcing element of the carcass reinforcement which is closest to said inner surface of the cavity of two distinct parts of the tire is greater than 1.15.

2. The tire according to claim 1, wherein the metal reinforcing elements of at least one layer of the carcass reinforcement are cords having at least two layers and wherein at least an inner layer is sheathed with a layer consisting of a crosslinkable or crosslinked rubber composition.

3. The tire according to claim 1, wherein or that the cords have, in the permeability test, a flow rate of less than 10 cm³/min.

4. The tire having a radial carcass reinforcement consisting of at least one layer of reinforcing elements, said tire comprising a crown reinforcement, which is itself covered radially with a tread, said tread being joined to two beads via two sidewalls, wherein the metal reinforcing elements of at least one layer of the carcass reinforcement are non-hooped cords having at least two layers, at least an inner layer being sheathed with a layer consisting of a crosslinkable or crosslinked rubber composition, preferably one based on at least one diene elastomer, wherein, in a radial plane, at least over part of the meridian profile of the tire, the thickness of the rubber compound between the inner surface of the cavity of the tire and that point of a metal reinforcing element of the carcass reinforcement closest to said inner surface of the cavity is less than or equal to 3.5 mm and wherein, in a radial plane, the ratio between the thicknesses of rubber compound between the inner surface of the cavity of the tire and that point of a metal reinforcing element of the carcass reinforcement which is closest to said inner surface of the cavity of two distinct parts of the tire is greater than 1.15.

5. The tire according to claim 1 or 4, wherein, in a radial plane, over at least that part of the meridian profile of the tire on which the thickness of the rubber compound between the inner surface of the cavity of the tire and that point of a metal reinforcing element of the carcass reinforcement which is closest to said inner surface of the cavity is less than or equal to 3.5 mm, the thickness of the rubber compound forming the inner surface of the cavity of the tire is less than 1.7 mm.

6. The tire according to claim 1 or 4, wherein, in a radial plane, the ratio between the thicknesses of the rubber compound forming the inner surface of the cavity of the tire of two separate parts of the tire is greater than 1.15.

7. The tire according to claim 1 or 4, wherein the thickness of rubber compound between the inner surface of the cavity of the tire and that point of a metal reinforcing element of the carcass reinforcement which is closest to said inner surface of the cavity is less than or equal to 3.5 mm over at least two thirds of the meridian profile of the tire.

8. The tire according to claim 1 or 4, wherein, in a radial plane, at least over part of the meridian profile of the tire, the thickness of rubber compound between the inner surface of the cavity of the tire and that point of a metal reinforcing element of the carcass reinforcement which is closest to said inner surface of the cavity is greater than 3.5 mm.

9. The tire according to claim 8, wherein, the meridian length of a part of the profile of the tire, of which the thickness of rubber compound between the inner surface of the cavity of the tire and that point of a metal reinforcing element of the carcass reinforcement which is closest to said inner surface of the cavity is greater than 3.5 mm, is between 5 and 20 mm.

10. The tire according to claim 9, wherein, the meridian length of the profile of the tire comprises at most four parts, the thickness of rubber compound of which between the inner surface of the cavity of the tire and that point of a metal reinforcing element of carcass reinforcement which is closest to said inner surface of the cavity is greater than 3.5 mm.

11. The tire according to claim 9, wherein at least two parts of the profile of the tire, the thickness of rubber compound of which between the inner surface of the cavity of the tire and that point of a metal reinforcing element of the carcass reinforcement which is closest to the said inner surface of the cavity is greater than 3.5 mm, are centered to within 20 mm on the orthogonal projection of the shoulder ends of the tire onto the inner surface of the tire.

12. The tire according to claim 9, wherein at least two parts of the profile of the tire, the thickness of rubber compound of which between the inner surface of the cavity of the tire and that point of a metal reinforcing element of the carcass reinforcement which is closest to said inner surface of the cavity is greater than 3.5 mm, are centered to within 20 mm on the orthogonal projection onto the inner surface of the tire of the points on the outer surface of the tire which are intended to come into contact with the radially outermost point of a rim flange.

13. The tire according to claim 1 or 4 wherein the metal reinforcing elements of at least one layer of the carcass reinforcement are layered metal cords of [L+M] or [L+M+N] construction usable as reinforcing element of a tire carcass reinforcement, comprising a first layer C1 having L threads of diameter d₁ where L ranges from 1 to 4, surrounded by at least one intermediate layer C2 having M threads of diameter d₂ wound together in a helix with a pitch p₂ where M ranges from 3 to 12, said layer C2 being optionally surrounded by an outer layer C3 of N threads of diameter d₃ wound together in a helix with a pitch p₃, where N ranges from 8 to 20, and wherein a sheath consisting of a crosslinkable or crosslinked rubber composition based on at least one diene elastomer covers, in the [L+M] construction, said first layer C1 and, in the [L+M+N] construction, at least said layer C2.

14. The tire according to claim 13, wherein the diameter of the threads of the first layer (C1) is between 0.10 and 0.5 mm and wherein the diameter of the threads of the layers (C2, C3) is between 0.10 and 0.5 mm.

15. The tire according to claim 13, wherein the helix pitch with which said threads of the outer layer (C3) are wound is between 8 and 25 mm.

16. The tire according to claim 2 or 4, wherein the diene elastomer is chosen from the group formed by polybutadienes, natural rubber, synthetic polyisoprenes, butadiene copolymers, isoprene copolymers and blends of these elastomers.

17. The tire according to claim 2 or 4, wherein the crosslinkable or crosslinked rubber composition based on at least one diene elastomer has, in the crosslinked state, a secant modulus in extension less than 20 MPa.

18. The tire according to claim 1 or 4, wherein the crown reinforcement is formed from at least two working crown layers of inextensible reinforcing elements, which are crossed from one layer to the other making angles of between 10° and 45° with the circumferential direction.

19. The tire according to claim 1 or 4, wherein the crown reinforcement also includes at least one layer of circumferential reinforcing elements.

20. The tire according to claim 1 or 4, wherein the crown reinforcement is supplemented, radially to the outside, by at least one supplementary protective ply consisting of elastic reinforcing elements oriented to the circumferential direction at an angle of between 10° and 45° and in the same sense as the angle made by the inextensible elements of the working ply that is radially adjacent thereto.

21. The tire according to claim 1 or 4, wherein the crown reinforcement further includes a triangulation layer formed from metal reinforcing elements making angles of greater than 60° with the circumferential direction.

22. The tire according to claim 2, wherein the rubber composition is based on at least one diene elastomer.

23. The tire according to claim 3, wherein said flow rate is less than 2 cm³/min.

24. The tire according to claim 8, wherein said thickness of rubber compound is greater than 4 mm.

25. The tire according to claim 17, wherein said secant modulus in extension is less than 12 MPa.
